(19) United States
(12) Patent Application Publication
(10) Pub. No.: US 2007/0152866 A1
(43) Pub. Date: Jul. 5, 2007

(54) Detection, location, and characterization of buried explosive devices and weapon caches

(76) Inventor: Mitchell C. Nelson, Morristown, NJ (US)

Correspondence Address: Mitchell P. Novick, Esq.;Law Offices Of Mitchell P. Novick, 66 Park Street, Montclair, NJ, 07042, US

(21) Appl. No.: 11/605,719

(22) Filed: Nov. 28, 2006

Related U.S. Application Data
(60) Provisional application No. 60/740,230, filed on Nov. 28, 2005.

(51) Int. Cl. G01S 13/88; G01V 3/12

(52) U.S. Cl. 342/22; 342/27; 342/90

(57) ABSTRACT

Embodiments of this invention utilize Fraunhofer diffraction to detect, locate, and characterize buried objects, and, in particular, weapons caches and/or potentially dangerous explosive devices, are to be detected and characterized according to rough size, shape, and reflectivity with respect to the probe energy (ultrasound, microwave, milliwave, etc.). Size is obtained by measuring the spatial pattern and/or width of the Fraunhofer diffraction wave. Reflectivity is obtained by normalizing the reflected energy with respect to the energy reaching the target object and the size of the reflective area of the target object.

### CROSS-REFERENCES TO RELATED APPLICATIONS.

This application claims the benefit of U.S. Provisional Application for Patent, Ser. No. 60/740,230, filed Nov. 28, 2005, the contents of which are hereby incorporated by reference in their entirety.

### FIELD OF THE INVENTION

An embodiment of the present invention is a device and method for use in detection and location of buried objects, specifically buried explosive devices and weapons caches.

Countering Terrorism

This invention may be utilized in countering terrorism. Buried and/or concealed explosive devices are commonly employed in terrorist activities. As part of efforts to counter terrorism, there is an urgent need to detect and locate buried explosive devices and weapons caches prior to their denotation/use by terrorists. An embodiment of this invention will aid in this detection and location prior to detonation/use.

### BACKGROUND OF THE INVENTION

It is well known in the prior art that electromagnetic and/or mechanical/acoustic waves can be used to detect and locate objects. Typical implementations of such waves are RADAR, SONAR, and similar technologies. However, the prior art works best with detection and location of (1) relatively large objects which (2) only have to be generally characterized.

In particular, the prior art does not effectively detect, locate, and characterize potentially dangerous explosive devices which are concealed or buried. A buried device presents its own unique challenges to detection, including without limitation, finding the device among the various solids comprising the ground or burial environment, distinguishing the device and its composition from its surroundings, and determining the size, hardness, and other physical characteristics of the device.

### BRIEF SUMMARY OF THE INVENTION.

An object of the present invention is to provide a device and/or system to detect a buried or concealed object.

Another object of the present invention is to provide a device and/or system to locate a buried or concealed object.

Still another object of the present invention is to provide a device and/or system to determine physical characteristics of a buried or concealed object.

Yet another object of the present invention is to provide a method to detect a buried or concealed object.

Still another object of the present invention is to provide a method to locate a buried or concealed object.

Yet another object of the present invention is to provide a method to determine physical characteristics of a buried or concealed object.

Embodiments of this invention utilize Fraunhofer diffraction to detect, locate, and characterize buried objects, and, in particular, weapons caches and/or potentially dangerous explosive devices, are to be detected and characterized according to rough size, shape, and reflectivity with respect to the probe energy (ultrasound, microwave, milliwave, etc.). Size is obtained by measuring the spatial pattern and/or width of the Fraunhofer diffraction wave. Reflectivity is obtained by normalizing the reflected energy with respect to the energy reaching the target object and the size of the reflective area of the target object.

### BRIEF DESCRIPTION OF THE SEVERAL VIEWS OF THE DRAWING

FIG. 1 is a schematic diagram of an embodiment of the present invention, a method for detection of subsoil objects using ultrasound or other directed energy.

FIG. 2 is a schematic diagram of a subsoil transducer utilized in an embodiment of this invention.

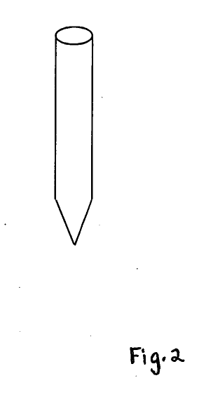

FIG. 3 is a schematic diagram of a subsoil transducer array utilized in an embodiment of this invention.

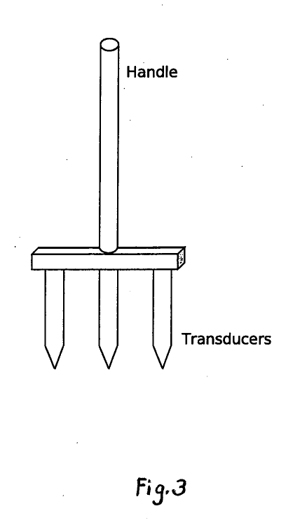

FIG. 4 is a flow chart of a method embodiment of this invention.

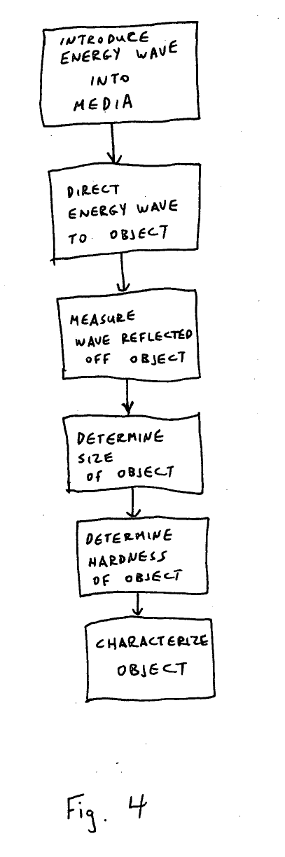

FIG. 5 is a schematic diagram of a device or system embodiment of this invention.

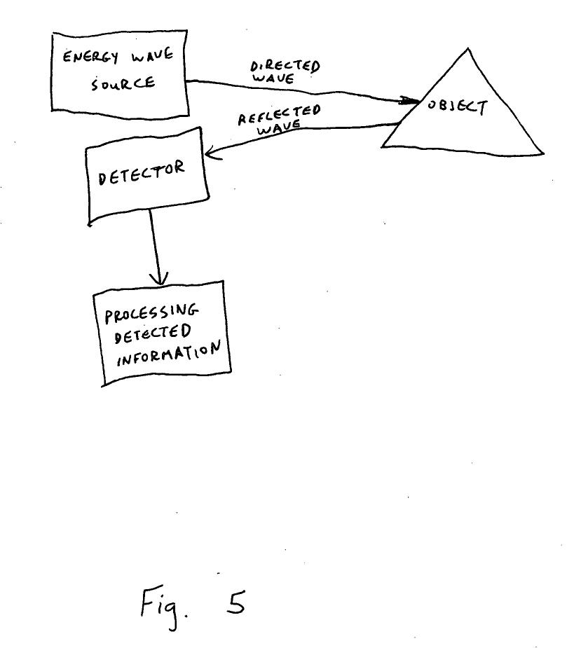

### DETAILED DESCRIPTION OF THE INVENTION

Embodiments of this invention utilize Fraunhofer diffraction to detect, locate, and characterize buried objects, and, in particular, (1) buried containers and (2) potentially dangerous explosive devices, are to be detected and characterized according to rough size, shape, and reflectivity with respect to the probe energy (ultrasound, microwave, milliwave, etc.). Size is obtained by measuring the spatial pattern and/or width of the Fraunhofer diffraction wave. Reflectivity is obtained by normalizing the reflected energy with respect to the energy reaching the target object and the size of the reflective area of the target object. Fraunhofer diffraction is well known in the relevant art.

Ultrasound reflectivity is strongly related to hardness. Reflectivity is a function of the acoustic impedance of the material as contrasted to that of the media in which it is embedded. Acoustic impedance is the product of the density and the speed of sound in the material, i.e. properties that are related to hardness.

Concealed or terrorist explosive devices that are designed to be harmful to humans include a significant amount of hard materials, and have a significant size, as set by basic considerations of physics, energetics of chemical explosives, and the statistics or probabilities for achieving the desired result. Therefore, size and hardness are essential properties of harmful terrorist or concealed explosive devices and these properties are the most relevant for assessing the threat likelihood of a possible explosive device.

The buried object may be characterized based upon the obtained measurements, to determine size and hardness. Other physical properties of the buried object may also be characterized in this manner.

Buried containers used to stash single or multiple weapons and explosives are similarly, made of materials that have significant contrast for acoustic energy, in soils found in many parts of the world, including the Mid-East. Such objects can be found and characterized by this device and/or method.

Once the object's physical characteristics have been determined, the characteristics may be compared to the corresponding characteristics of known explosive devices or portions thereof to assess whether the located buried object appears to be a potentially explosive device or buried container. Equipment and techniques to accomplish these comparisons are well known in the relevant art.

### A FIRST EMBODIMENT

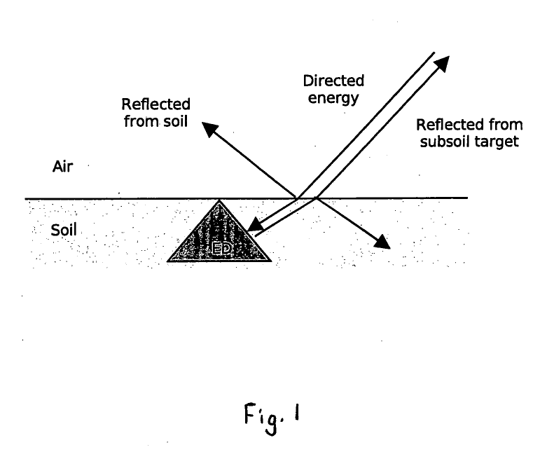

In one embodiment of this invention, buried objects are detected and characterized as follows. A probe emits an energy wave, preferably utilizing equipment and techniques well known in the relevant art. The energy wave used is preferably acoustic or microwave; however, other portions of the electromagnetic spectrum may be employed. The probe energy wave is directed towards the ground at an incident angle such that the ground surface reflection is not towards the detector array (FIG. 1). Measurements are taken of reflections received at the detector, preferably utilizing equipment and techniques well known in the relevant art. Any surfaces of the buried object which are directed towards the detector provide reflections with minimal background from the ground surface reflection and that are thereby more easily detected and measured. These reflection-based measurements may be corrected for refraction at the ground surface (i.e., ground-air interface).

This embodiment is particularly focused on detecting, locating, and characterizing explosive devices concealed under soil, but buried at shallow depth in the ground.

### A SECOND EMBODIMENT

Another embodiment of this invention comprises introducing underground a probe energy wave, preferably utilizing equipment and techniques well known in the relevant art. Preferably, the energy wave is acoustic; however, electromagnetic probe energy may be employed. A sensor array is introduced underground to receive the wave reflected by the target object through the soil, preferably utilizing equipment and techniques well known in the relevant art. The probe preferably comprises one or more transmitting transducers and three or more receiving transducers. Theoretically, two receiving transducers are sufficient to locate objects and measure the net reflected energy in the direction from the object to the receivers. Similarly, three receiving transducers are sufficient to measure the size and normalized reflectivity of the object when the receiver array is located in the central portion of the reflected wave. Objects are located by any combination of triangulation, correlation, and/or time delay, preferably utilizing equipment and techniques well known in the relevant art. The probe is plunged into the ground when it is desired to detect the buried explosive device. An embodiment of a preferred probe for this use is described elsewhere in this document.

### A THIRD EMBODIMENT

Another embodiment of this invention comprises an ultrasonic transducer for subsoil ultrasound detection and location of various objects including weapons and explosive devices. The transducer is preferrably constructed in a firm or hard housing material, drawn or sharpened to a point so that it can be jabbed into the ground, and the transducer is provided with a matching layer to match as closely as practical, the acoustic impedance of the range of soils that the transducer will be used in, preferably utilizing equipment and techniques well known in the relevant art.

### A FOURTH EMBODIMENT

Still another embodiment of this invention comprises a sensor array for subsoil ultrasound detection and location of various objects including weapons and explosive devices. The array comprises an arrangement of two or more transducers such as described above, with one, none, or several similar transducers such that the set can be conveniently plunged into the ground.

In all of the embodiments, there may be variations to accommodate specific environmental conditions, concealing media, or potential explosive devices or caches and permit this invention to be more efficiently and effectively used.

Therefore, although this invention has been described with a certain degree of particularity, it is to be understood that the present disclosure has been made only by way of illustration and that numerous changes in the details of construction and arrangement of parts may be resorted to without departing from the spirit and scope of the invention.

We claim:

1. A method of characterizing an object concealed in a concealing environment, the method comprising:
(A) introducing an energy wave into the concealing environment;
(B) directing the energy wave towards the object;
(C) measuring a reflected wave produced when the energy wave encounters the object;
(D) determining a characteristic of the object from the reflected wave; and
(E) characterizing the object based upon the determined characteristic.

2. A system for characterizing an object concealed in a concealing environment, the system comprising:
an energy wave;
means for directing the energy wave towards the object;
means for measuring a reflected wave produced when the energy wave encounters the object, producing a measurement;
means for determining a characteristic of the object from the measurement; and
means for characterizing the object based upon the determined characteristic.
